(19) United States
(12) Patent Application Publication
(10) Pub. No.: US 2015/0172399 A1
(43) Pub. Date: Jun. 18, 2015

(54) SYSTEM AND METHOD OF AUTOMATIC SHARING OF ONLINE ACTIVITIES

(71) Applicant: Dong Liu, Lexington, MA (US)

(72) Inventor: Dong Liu, Lexington, MA (US)

(21) Appl. No.: 14/108,204

(22) Filed: Dec. 16, 2013

(51) Int. Cl. H04L 29/08; H04L 12/26

(52) U.S. Cl. CPC H04L 67/22; H04L 43/10

(57) ABSTRACT

A method and system is designed and implemented to allow users to share their online activities with family members, friends, colleagues, neighbors, merchants, advertisement sponsors, and other people, while still concentrating on their own tasks on the internet. The system also provides online forums, profile-based advertisement auction, group-based mobile e-commerce, and other facilities, so members in a group can communicate and interact among themselves. The automatic sharing of user activities is realized by software extensions or plug-ins that are embedded in a web browser. The users can submit their activities to multiple groups, selected by a click on the icons of groups. The automatic sharing aspect of the proposed system has been implemented, and the proposed functions have been successfully tested. The mechanisms that are proposed and described in detail include profile-based advertisement auction on individual users, group-based mobile e-commerce, and community-based innovation incubator.

### CROSS-REFERENCE TO RELATED APPLICATION

This application claims the benefit of provisional patent application Ser. No. 61/737,958, filed on Dec. 17, 2012 by the present inventor.

### FEDERALLY SPONSORED RESEARCH

Not applicable

### SEQUENCE LISTING OR PROGRAM

The critical part of the computer code is explained in the figures and specification. The important source code is submitted as text files in this electronic submission.

### BACKGROUND

1. Field

This application related to the internet-based social networking, specifically to the sharing of online experiences among groups of people.

2. Prior Art

Many social network web sites like Facebook (www.facebook.com) require a user to click a button, copy and paste a URL link, or perform some action, in order to submit a web page to the server, so the public or group can be notified of the user's interest. Some browser plug-ins like AddThis (https://addons.mozilla.org/en-US/firefox/addon/addthis/) tries to simplify this process, and provides a button or a menu for the user to submit the URL to some social network site in one or two clicks.

The disadvantage of these social network sites and these browser plug-ins is that the users need to perform some actions in order to submit the interesting URL to the social network site servers. The burden of manually submitting interesting content not only dissuade users from submitting as frequently as they wish, but also distracts the users from their online activities. Another disadvantage is that the recipients only know that someone is interested in some content, but has no information about the level of interest or the context of the content.

A Mozilla Firefox browser plug-in, SimilarWeb (https://addons.mozilla.org/en-US/firefox/addon/similarweb-sites-recommendatio), detects the website that a user is visiting, and recommend other websites that may be interesting to that user. The recommendation of potentially interesting web sites does not require any action from the user, and does not interfere with the user's online activity. SimilarWeb is not directly related to social network and sharing of users' online activity.

### DRAWINGS—FIGURES

FIG. 1 shows the overall architecture for automatic sharing of user online activity in one embodiment.

FIG. 2 shows the unactivated Neicca extension in Firefox browser in one embodiment.

FIG. 3 shows the activated Neicca extension in one embodiment, with the Neicca sidebar page in the left side of browser.

FIG. 4 shows that in one embodiment, one member of a group browses a web page. That page is recorded as an interesting page to all groups that the user participated in.

FIG. 5 shows that in one embodiment, a user B, who is in a group with a user A, can see the page that is interesting to user A.

FIG. 6 shows that in one embodiment, a user selects the groups to which the online activities are submitted.

FIG. 7 shows that in one embodiment, a user “User A” submits online activities to different groups at different times.

FIG. 8 shows that in one embodiment, users in different groups will see different lists of interesting online activities.

FIG. 9 shows that in one embodiment, when Neicca extension is not installed or not turned on, a user can manually submits web page URL to selected groups in the main page of Neicca.

FIG. 10 shows structure of file for Neicca Extension for one embodiment,

FIG. 11 shows the code structure of Neicca Extension for one embodiment,

FIG. 12 shows the source code of neiccaOverlay.xml used in one embodiment.

FIG. 13 shows the code in neiccaOverlay.js that in one embodiment, captures the online activity and submits to Neicca Server.

FIG. 14 shows the structure of files in Neicca Server for one embodiment.

FIG. 15 shows the code structure of a part of Neicca Server in one embodiment that handles user activity data Submitted By Neicca Extension.

FIG. 16 shows the source code in one embodiment for Neicca Server domain class, which are WebPage, WebSite, and WebEvent.

FIG. 17 shows the source code of WebEventController.groovy, which in one embodiment handles the submission of web events.

FIG. 18 shows the source code of WebEventService.groovy, which in one embodiment handles the submission of web events.

FIG. 19 shows the source code of displaySidebarPage.gsp, which in one embodiment submits a user's online activity to multiple groups.

### DETAILED DESCRIPTION

### Overview

The wide-spread use of computing devices and availability of internet connection are creating a new medium of communication for human being to acquire knowledge and share their experience. The need to acquire knowledge has been satisfied with direct access to web sites from all places of the world. But the need for human being to share thoughts and experiences is so far being served inadequately by social network web sites like Facebook and LinkedIn. This provisional patent application is to describe a method and a system that enables the detailed sharing of people's online experiences without compromising people's productivity.

The first embodiment of the proposed method and system is a web-based software system named Neicca, which implies neighborhood and community. The Neicca software system utilizes a software component, Neicca extension, which is embedded in a user's web browser. The current implementation of Neicca extension monitors what web page is opened by a user, how long a web page is viewed by a user, how much scrolling is done by a user, what content is highlighted by a user, what web page is saved by a user, and what web page is bookmarked by a user. In the future, Neicca extension can monitor what location a user is, what online image, audio and video is viewed by a user, how long these multimedia content is watched by a user, as well as many other activities performed by a user on a web page. The future development of Neicca extension may also include better analysis of the content of web pages in order to determine the difference between interesting web pages and non-interesting web pages. The specific content that attracts the interest of a user can be further analyzed and presented as answers to other users' questions.

Another component of the implemented system is a web application server, Neicca server. Neicca server receives data from Neicca extension, analyze every user's online activities, select web pages that are interesting to each member of a group, and present these interesting to the group members. Current implementation of Neicca server also provides an online forum for each group, so users can discussion anything that concerns them. In the future, Neicca server will provide blogs, user calendars, instant messages, audio and video communications, location-based member notification and discovery, real-time identification of user tasks, and real-time machine-based or member-offered help to these tasks.

The automatic sharing of users' online activities also leads to better ranking of web pages than current algorithms of search engines such as page rank used by Google. The page rank algorithm claimed by Google uses the number of pages that references the target page to determine the desirability of the target page. In practice, Google's ranking of web pages can be abused by those who create many meaningless web pages that reference their core web page, in order to raise the ranking of the pages that carries their messages. In Neicca systems, detailed sharing of online activities allows the Neicca server to determine which web pages are most interested to users, therefore are most suitable to be recommended to other users with similar needs.

In the future, the proposed online activity sharing system will include individual-based advertisement auction on each user. The advertisement sponsors will be allowed to perform data mining on the anonymized user data and identify a list of users who are most likely to respond to their advertisement.

After entering a bid for access to each individual user based on anonymized profile data, the sponsor may win the auction, therefore be allowed to present display advertisement and click-through advertisement to such user.

The future embodiments will also include the proposed group-based and in-store merchandize promotion. Accessing Neicca system through internet connection or phone, a user can find out nearby stores participating in Neicca system, as well as a group of members near that location. The stores can launch promotions based on Neicca user location data in real time. The user can organize group purchase in a participating store, and enjoy group-based discount on certain products and services.

### Overall Architecture of Automatic User Online Activity Sharing in Neicca System

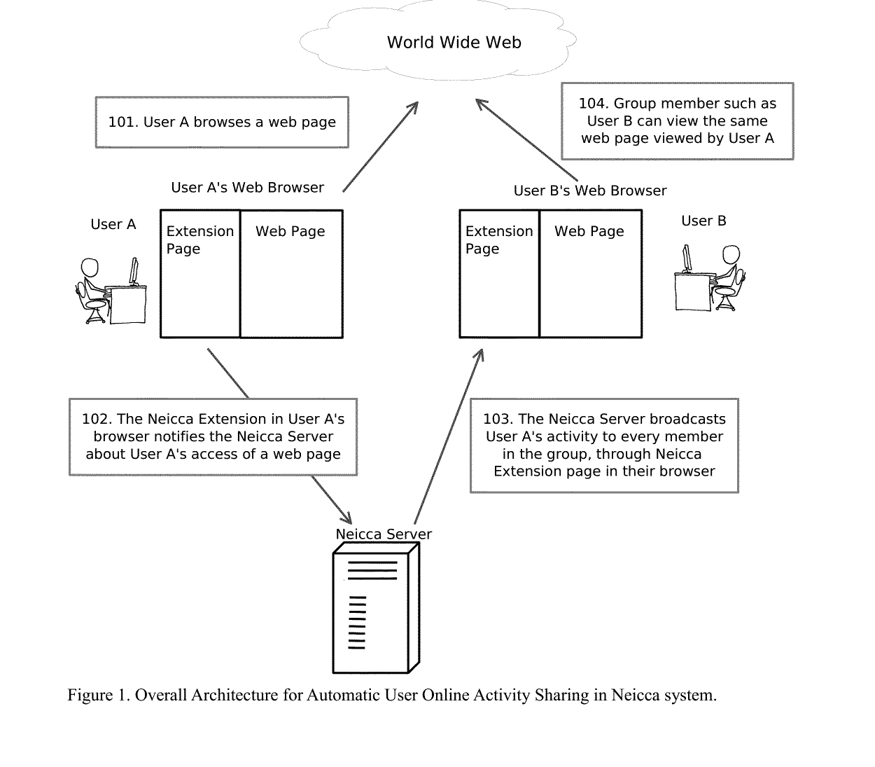

The information flow for the function of automatic user online activity sharing is illustrated in FIG. 1.

When a user wants to share his online activity with the selected groups, he can start the Neicca extension on the browser. A sidebar page will appear on the left side of the browser, displaying the selected groups and the online activities performed by the groups. Most importantly, the sidebar page acts as a reminder that the user's online activity is being shared among the selected groups, and the user is no longer enjoying complete privacy.

The user can concentrate on performing his tasks online in the right side of the browser, which has all the capabilities of the browser. The user's online activity, such as what web pages he is reading, how much interest he has on each page, and what portion of the web page he highlights, etc., will be submitted to Neicca server by the Neicca extension embedded in the browser.

The Neicca server collects the online activities from all the users that participate in the sharing. The most interesting web pages to each group are calculated, and the resulting list is displayed in Neicca extension sidebar page for each user who chooses to share the online activities. Every user in the group can see a list of web pages interesting to the group, click on one web page link, and read an interesting page in the main window in the right part of the browser.

The automatic sharing of online activities can be started and stopped by the user with a click on the Neicca extension button. The groups to which these activities are submitted are clearly displayed to the user. Each group can be switched on or off by the user with a click on the group icon. The sharing of detailed user manipulation of the web pages greatly enhances the sharing of online surfing experiences, as compared to the commonly used method of submitting only the link. It also eliminates the burden of sharing, so the user can concentrate on his tasks online. The Neicca extension sidebar page is also automatically updated, thus providing assistance to user's tasks in real time, either from the Neicca server or from other members of the group.

Thus the Neicca extension of the internet browser constitute a method and a system to detect, submit, and share a user's online activities.

### User Experience of Automatic Sharing Through Neicca Extension In A Browser

The user interacts with Neicca system mostly through the Neicca extension embedded in a browser.

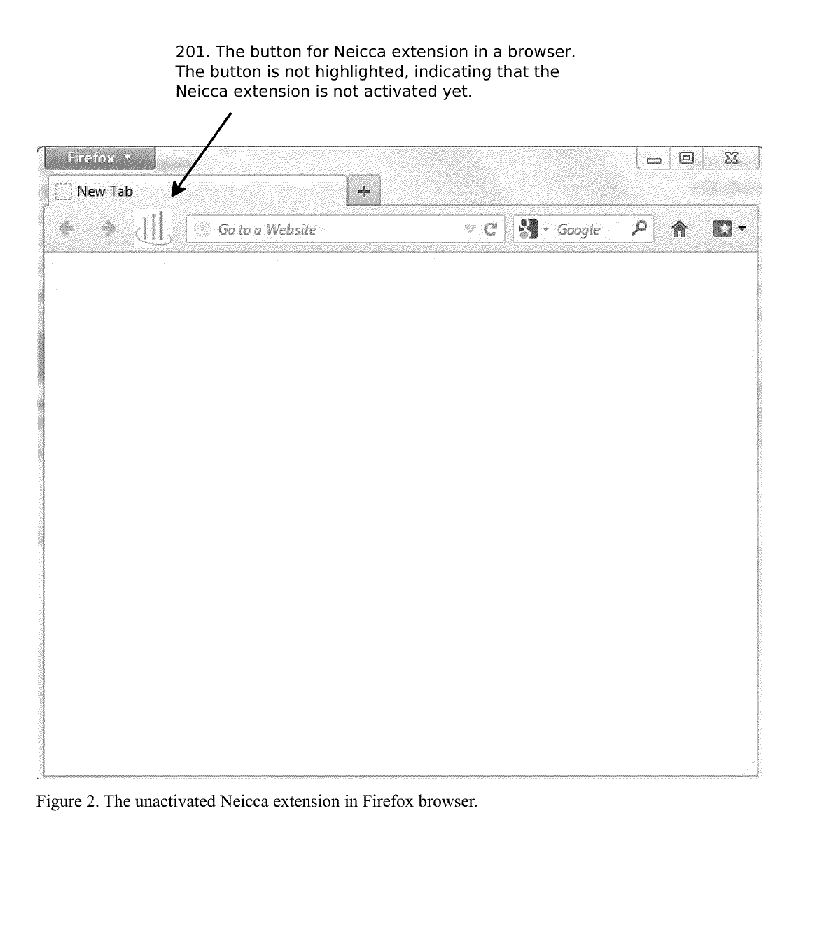

First, the user, “User A,” needs to install Neicca extension into the browser that he is using. As show in FIG. 2, after the installation, the Neicca extension button 201 appears on the browser. When Neicca extension is not activated, the Neicca extension button appears plain and not highlighted. Inactivated Neicca extension will not do anything, thus preserving the user's privacy.

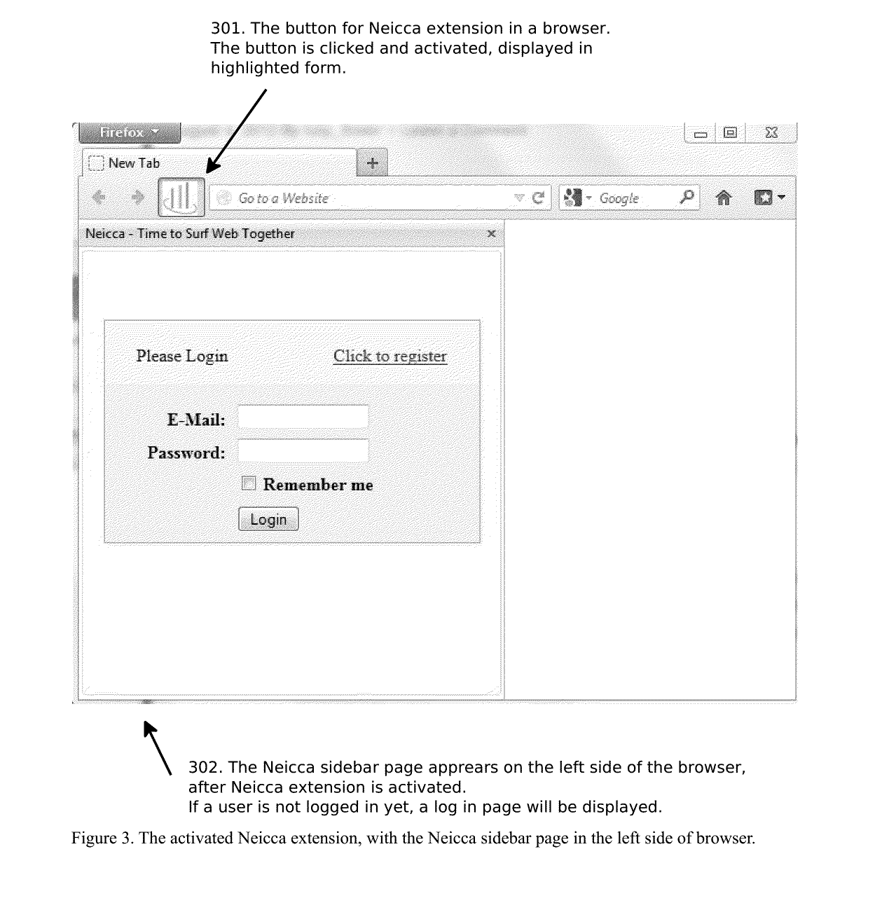

As shown in FIG. 3, when the user wants to share his online activity with the Neicca groups he participated in, he can click on the Neicca extension button, which by default is positioned on the top of the browser. The Neicca extension will be activated, and the button 301 will be displayed in highlighted form. The Neicca sidebar page will also be opened at the left of the browser, displaying group-related information. The Neicca sidebar page is also used as a reminder that the user's online activity is being shared, thus reducing the possibility of accidental invasion of user privacy.

Each user has his own account in the Neicca system. The user needs to identify himself and log in.

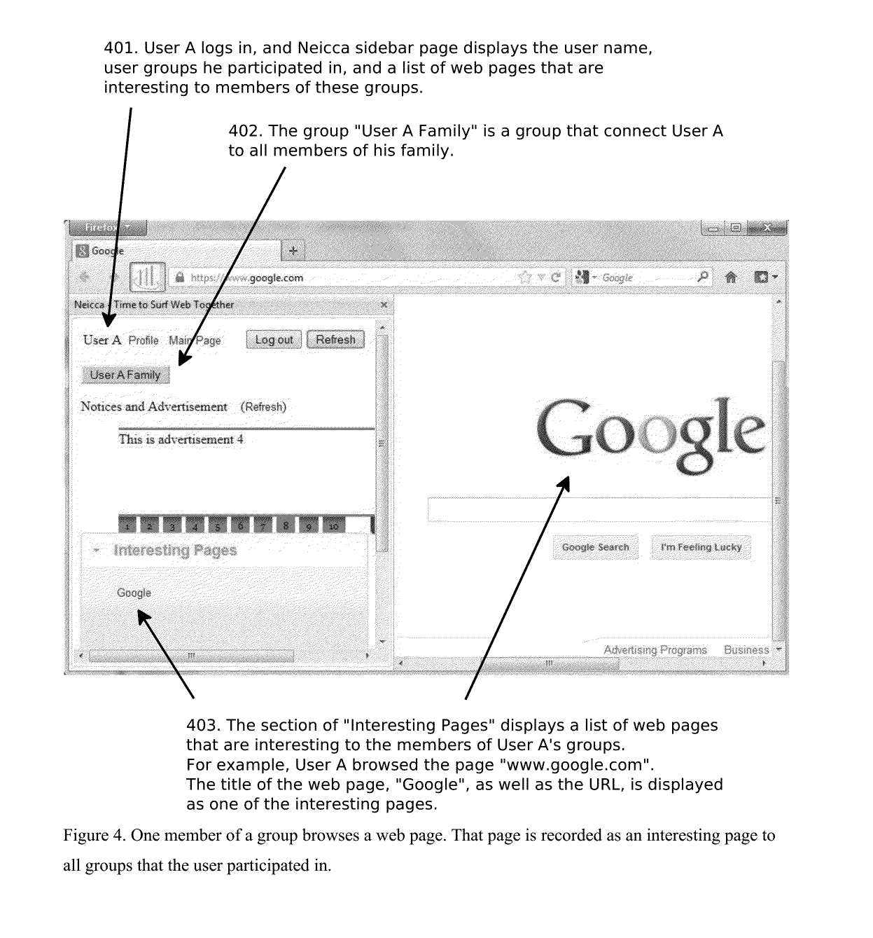

In FIG. 4, the user has successfully logged into Neicca system. His user name 401 is displayed in the Neicca sidebar page, along with the Neicca groups 402 he participated in. The online activities 403 he performed in the main browser window to the right will be automatically transmitted to Neicca server, and be broadcast to all the members of the Neicca groups that he selected to share. In the example illustrated in FIG. 4, the user studied the Google front page carefully, such as by scrolling up and down. The title and URL of the Google front page was transmitted to Neicca server, as well as the number of scrolling that the user performed on that page. The Neicca server determined that the Google front page is a page that the user truly interested in, and broadcast that page to all the members of the groups selected by the user.

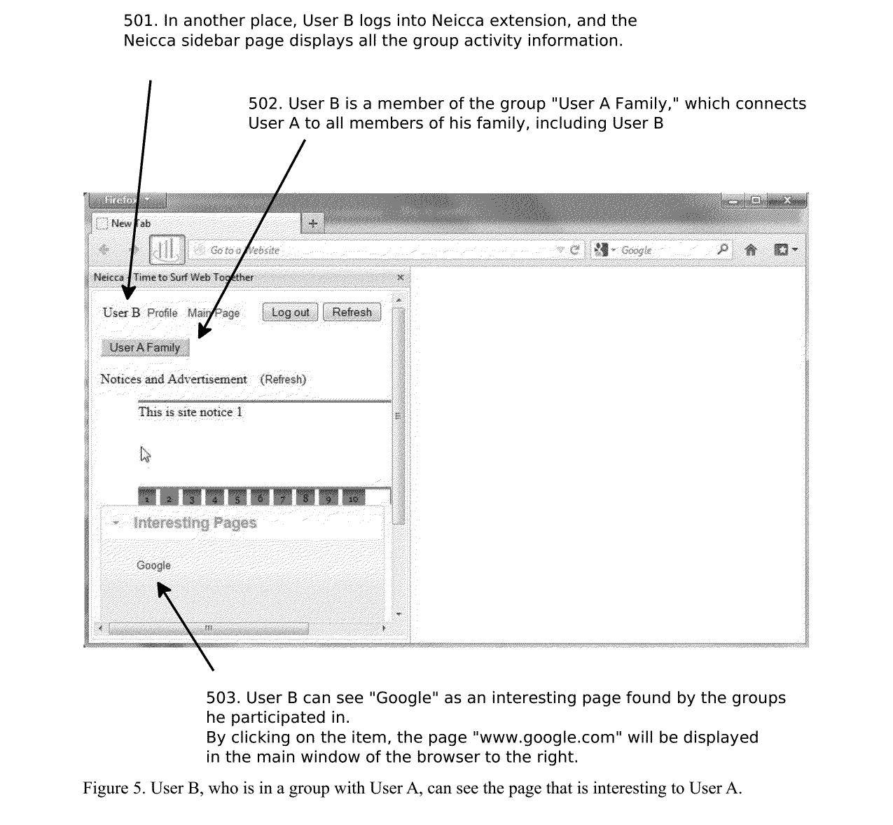

In FIG. 5, another user, “User B,” 501 is a member of the group 502 that includes the first user “User A.” User B can see that the Google front page 503 is one of the web pages interesting to members in the groups that he participates in. By clicking on the URL of the Google front page in the Neicca sidebar page, the Google front page will be displayed in the main browser window to the right.

The Neicca server receives detailed information on user's online activity, so it is capable of detecting user's interest in the web pages that are displayed in the browser. For example, when a user scrolls up and down through a web page, the actions are captured by Neicca extension and submitted to Neicca server. When a user highlights a part of web page, the highlighted content is submitted to Neicca server.

The captured user actions also include saving a web page, bookmarking a web page, and the duration of which a web page is viewed. In the future, there will be more user actions to be captured by Neicca extension, and submitted to Neicca server.

After acquiring detailed user actions on web pages, the Neicca server can summarize the level of interest on each page from all members of a group, and calculate a list of interesting pages to this group. The periodic updating of the Neicca sidebar page will bring the most recent list of interesting pages to every member in this group.

### User Experience of Online Activity Sharing Into Multiple Groups

Neicca sidebar page displays a list of the groups in which the user participated. The group icon 601 also changes color depending on whether the user's online activity is submitted to this group. This design helps to prevent the user from submit online activities to groups that he does not intend to share.

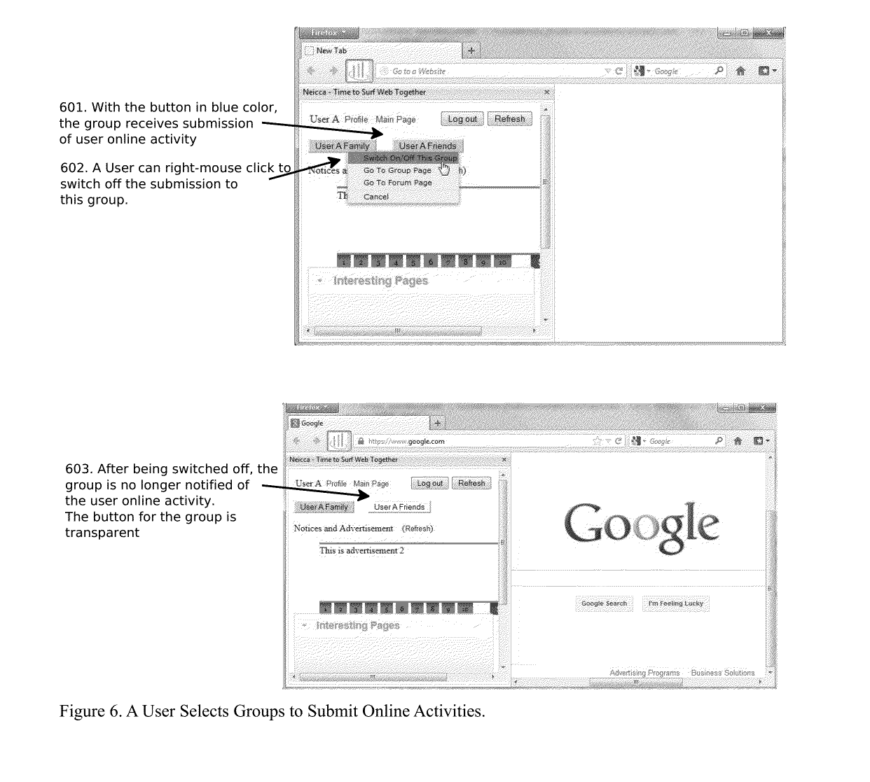

It is convenient for user to switch on and off the submission of activities. As illustrated in FIG. 6, the user can right-mouse click 602 on the group button, then click on the menu “Switch on/off This Group,” to turn on or off the submission of online activities to this group. The color of this group button will change according to the active or inactive state.

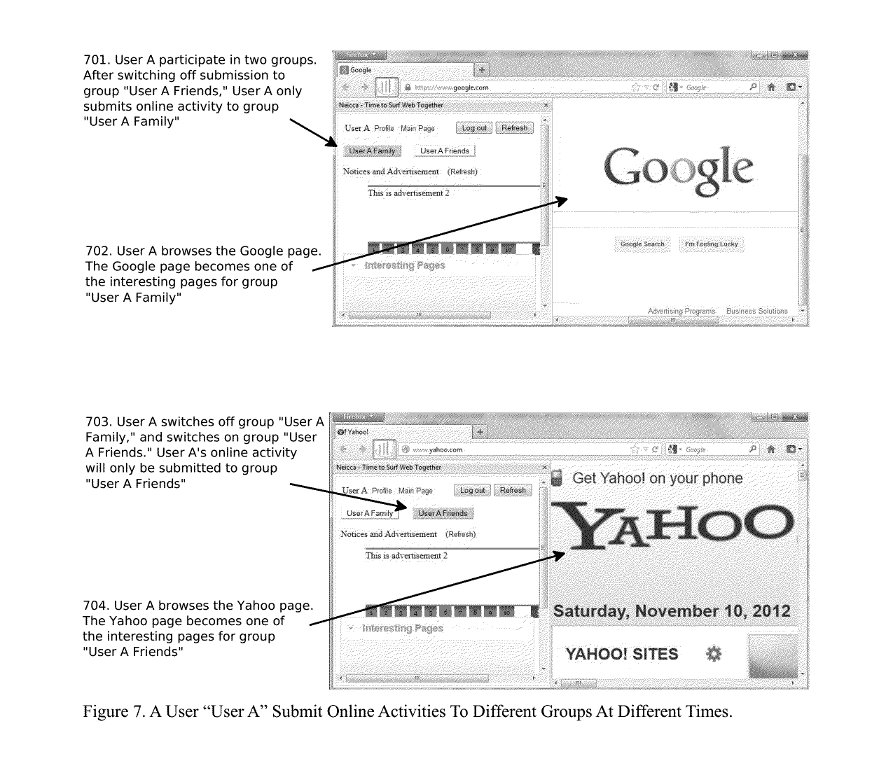

The user's online activities will only be submitted to the list of groups that are selected by the user to receive these activities. For example, in FIG. 7, a user “User A” first submits the browsing of the Google page to the group “User A's Family” 701. Then “User A” switches off the submission to “User A's Family,” and switches on submission to the group “User A's Friends.” Later, the browsing of the Yahoo page 703 by “User A” is shared into the group “User A's Friends.”

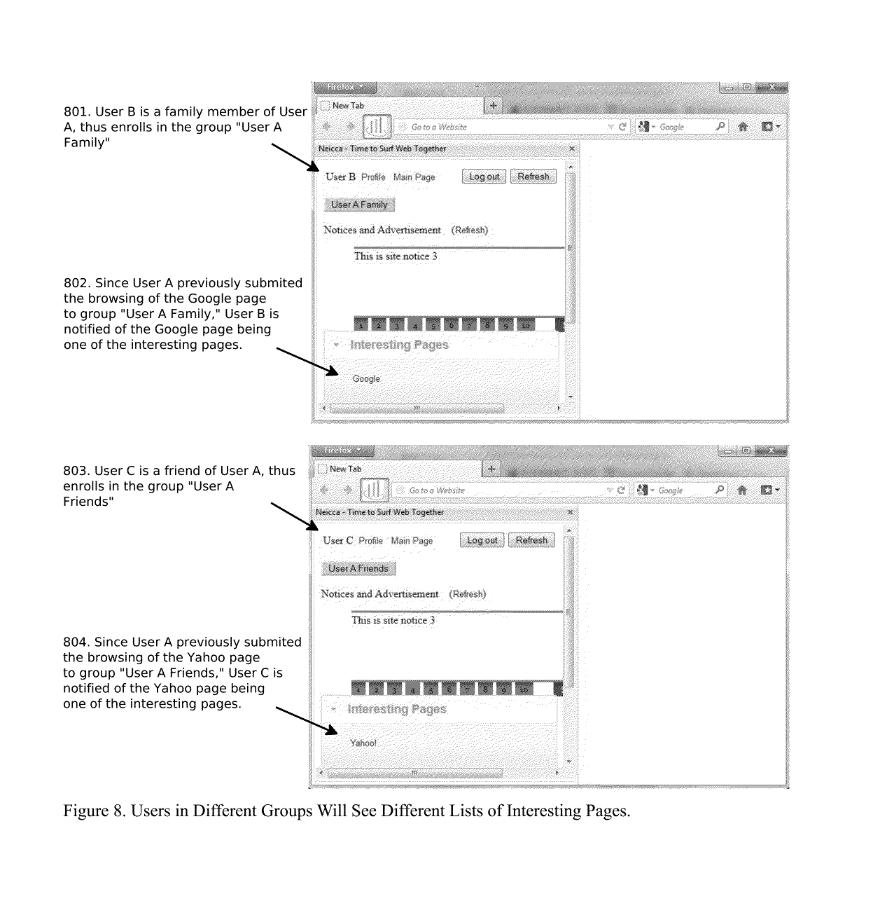

Shown in FIG. 8, the user “User B” 801 is a member of the group “User A's Family.” So the interesting page list for “User B” only shows the Google page 802 that “User A” submitted to the group “User A's Family.” The user “User C” 803 is only a member of the group “User A's Friends,” and he only sees the Yahoo page 804 that was submitted to that group.

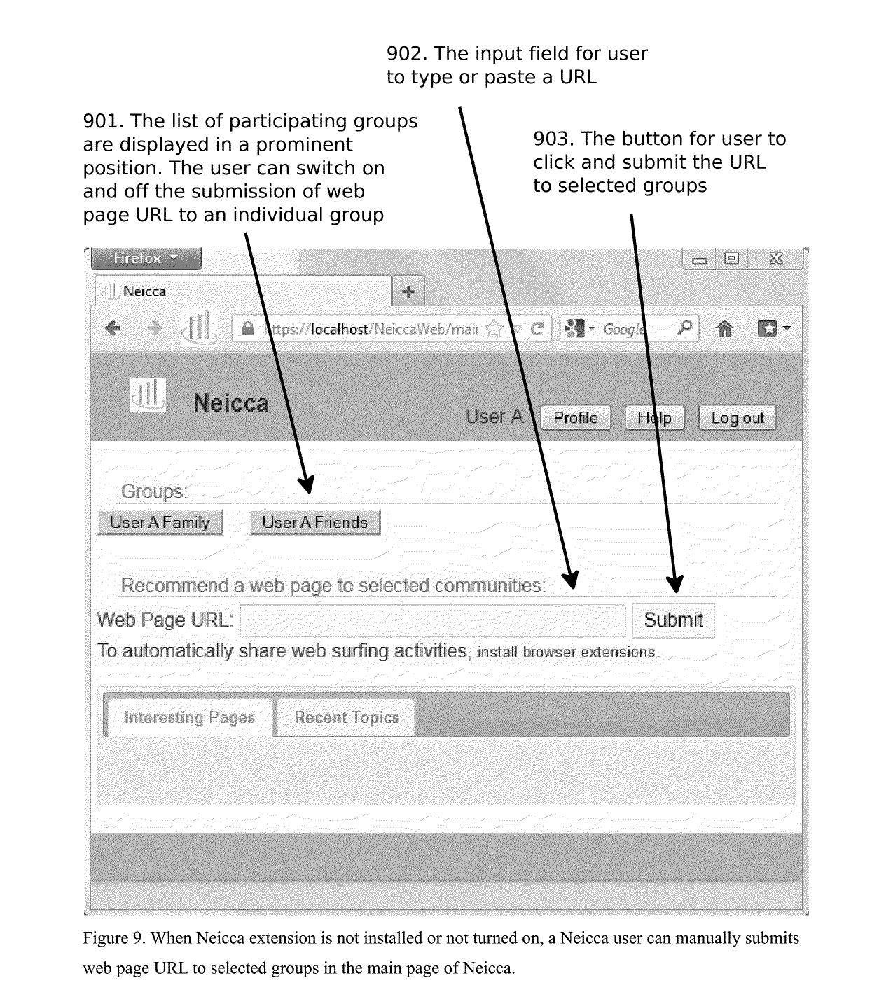

In the Neicca main page, as illustrated in FIG. 9, a user can copy a URL into an input field 902, click on “Submit” button 903, and explicitly submit this URL to a list of groups 901 that are set up to receive user activities. The mechanism and code for this feature in Neicca main page are exactly like the implementation in Neicca extension.

The convenience of submitting activities to multiple groups increases the efficiency and flexibility of sharing. The easy configuration of groups that receives the submission, and the strict restriction of visibility of these shared activities within the intended groups, gives users peace of mind about sharing their activities. Combined with automatic sharing mechanism, the proposed and implemented Neicca system turns the web surfing of individuals into an integrated community experience.

Thus the Neicca extension and the manual submission constitute a method and a system to submit and share a user's online activities among a plurality of groups.

### Neicca Extension Embedded in Browser

The Neicca extension is based on extension or plug-in technology provided by internet browsers like Mozilla Firefox and Google Chrome. For the time being, only the Neicca extension for Firefox browser is implemented and fully-functional. The Neicca extension for Microsoft Internet Explorer, Google Chrome, and other browsers will be developed in the similar fashion.

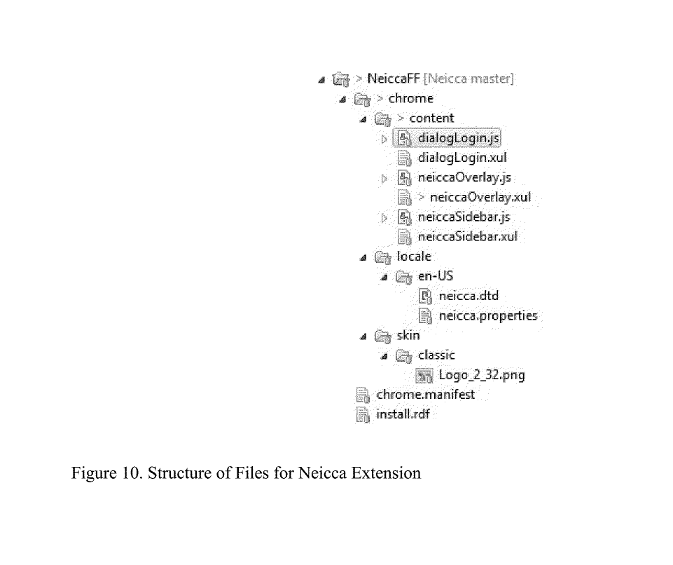

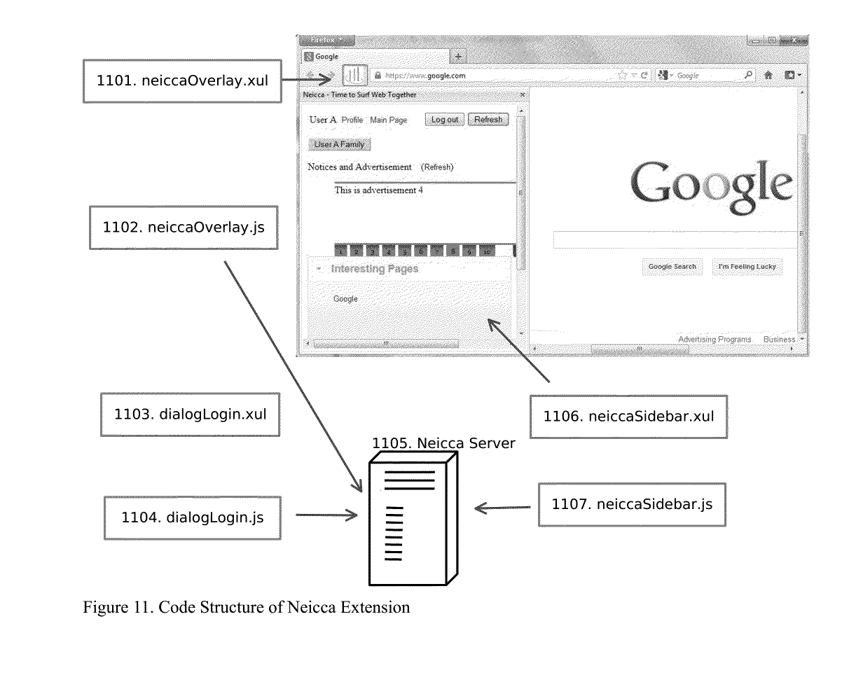

FIG. 10 displays all the files and their directory structure for Neicca extension. FIG. 11 shows the code structure of layout definition files, xul files, and programming logic files, js files.

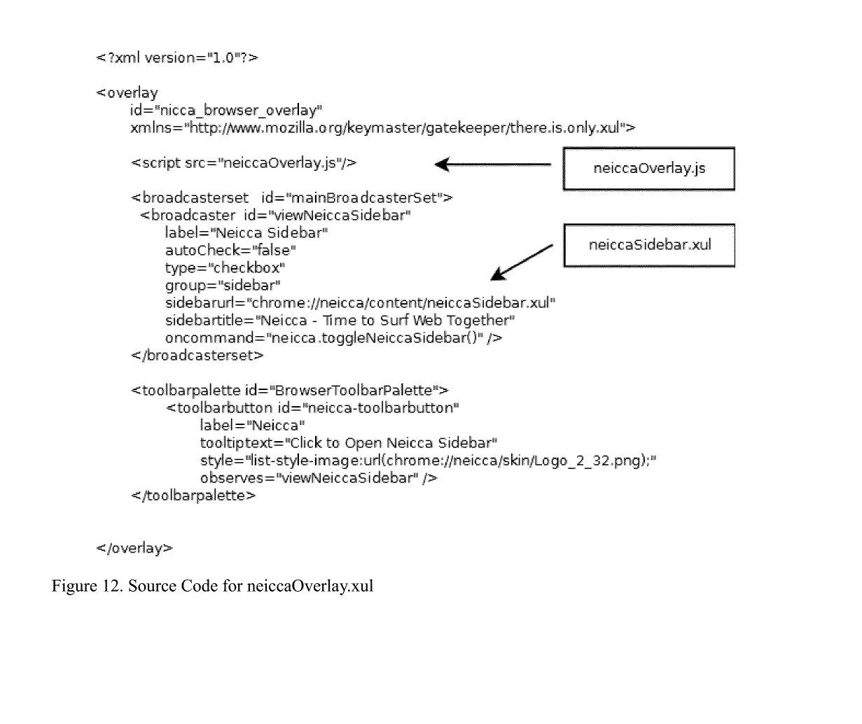

FIG. 12 displays the source code for the top-level layout definition file, neiccaOverlay.xul. This file defines the Neicca extension button, which by default is displayed beside the address bar of the browser. This xul file also defines a sidebar page window, and the sidebar page layout definition file, neiccaSidebar.xul. The file neiccaSidebar.xul in turn defines the programming logic file neiccaSidebar.js. The file neiccaOverlay.xul also defines the programming logic file at the top-level, neiccaOverlay.js. When it is run, the file neiccaOverlay.js may invoke a layout definition file dialogLogin.xul, which define a user login page in the sidebar window. The programming logic file dialogLogin.js is defined in dialogLogin.xul.

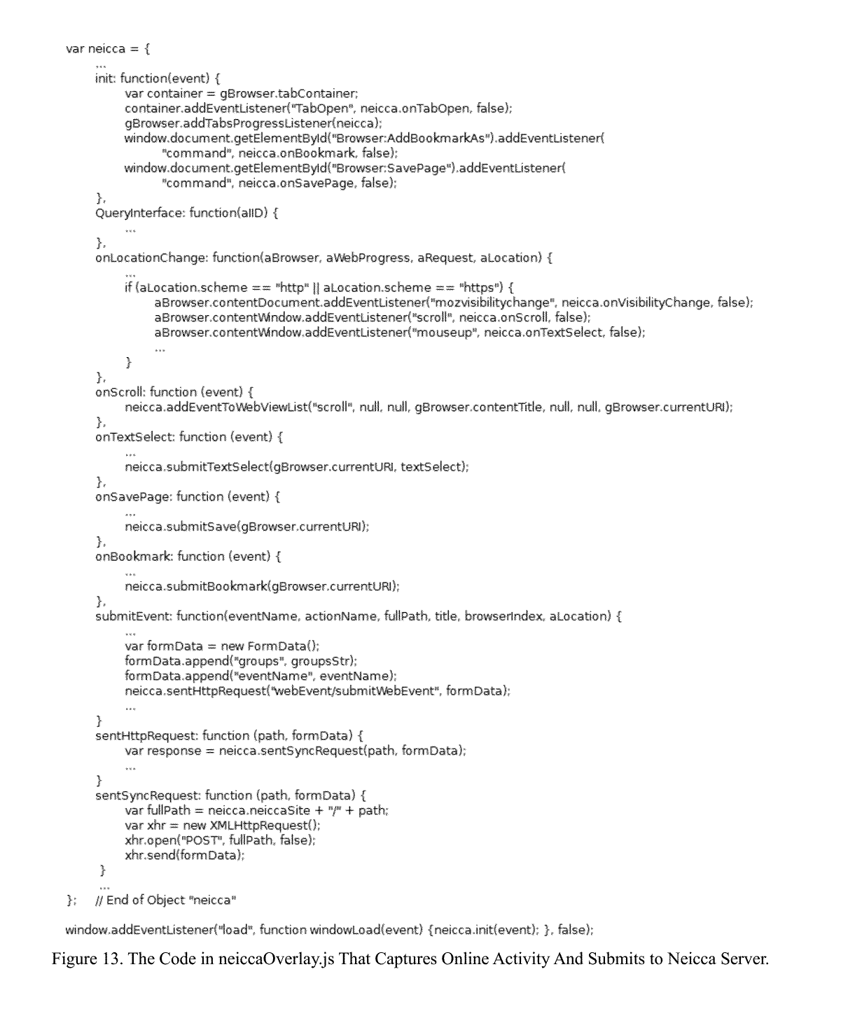

The programming logic file at the top level of Neicca extension, neiccaOverlay.js, manages the position of Neicca extension button, activates or inactivates Neicca extension, authorizes user login, detects user's online activity, and submits these activities to Neicca server. FIG. 13 displays a part of source code in neiccaOverlay.js that captures user's online activities and submits them to Neicca server.

The file neiccaOverlay.js will be run after Neicca extension is activated. The clause “window.addEvenListener” allows the browser window's “load” event to trigger the running of the function “neicca.init”. The function “neicca.init” adds a series of callback functions such as onLocationChange and onScroll, etc. to the corresponding events. When the user opens a new web page, scrolls up and down through a web page, or performs other online activities, the browser will call these registered functions such as onLocationChange and onScroll, etc. The function submitEvent prepares the data, and calls the function sentHttpRequest, which in turn calls the function sentSyncRequest. The function sentSyncRequest creates a XMLHttpRequest object, and submits the user's online activities to Neicca server.

The Neicca sidebar page is defined by neiccaSidebar.xul, and controlled by neiccaSidebar.js. The file neiccaSidebar.xul creates an empty iFrame in the sidebar window. The file neiccaSidebar.js sets the URL of the iFrame to a page served by Neicca server. Then the iFrame accesses the Neicca server, and displays the returned content in the sidebar window. The Javascript code in the fetched content updates the content periodically, so the user is presented with up-to-date information.

### Neicca Server

The Neicca server is a typical web application server utilizing Grails framework and MySQL database.

It provides HTTP-based web interfaces that collect user activities, update interesting web pages, facilitate group discussion, and provide many other functions. In the future, features could be added to further enhance the interaction and collaboration among the members, such as instant messaging with text, audio, and video, location-based notification and group gathering, calendar coordination of user activities, and activity-based friend matching, etc.

Grails is a web application framework based on Java, Groovy, dependency injection, and Model-View-Controller paradigm. Grails emphasizes tradition over explicit configuration. Many boiler-plate code for web application functions have been built into the Grails framework.

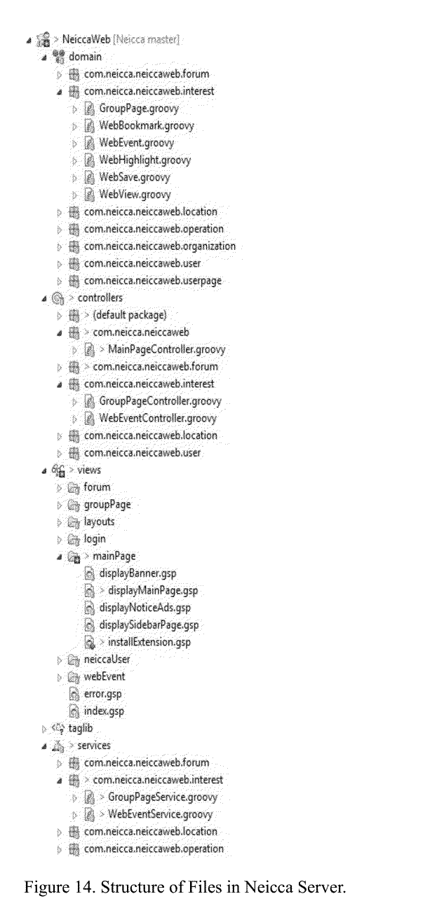

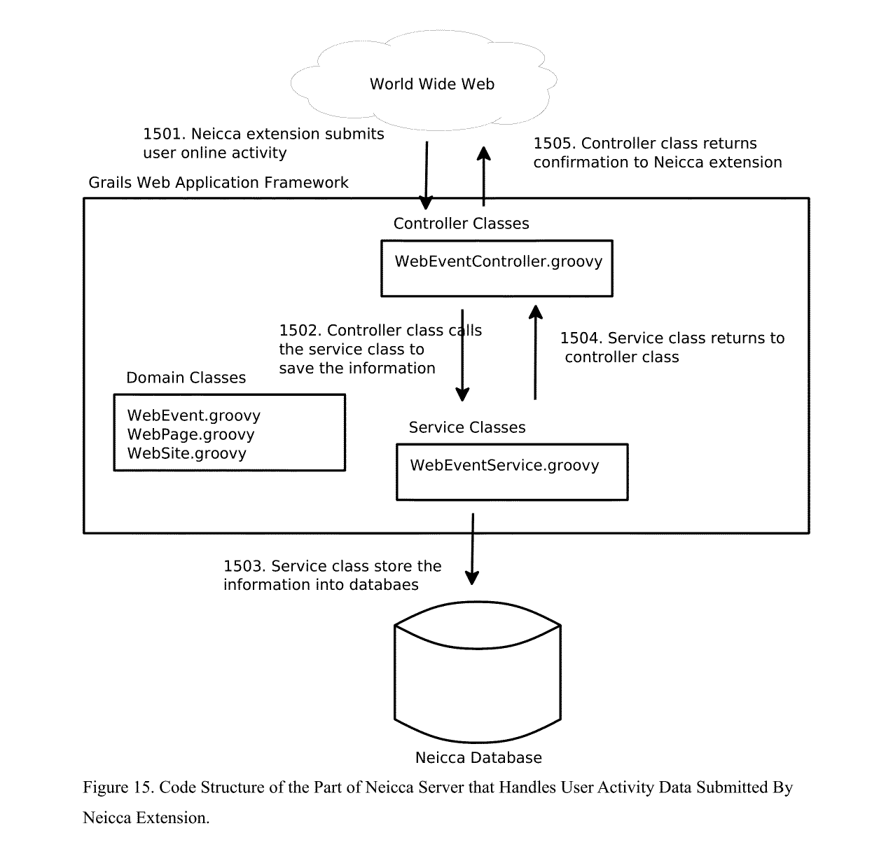

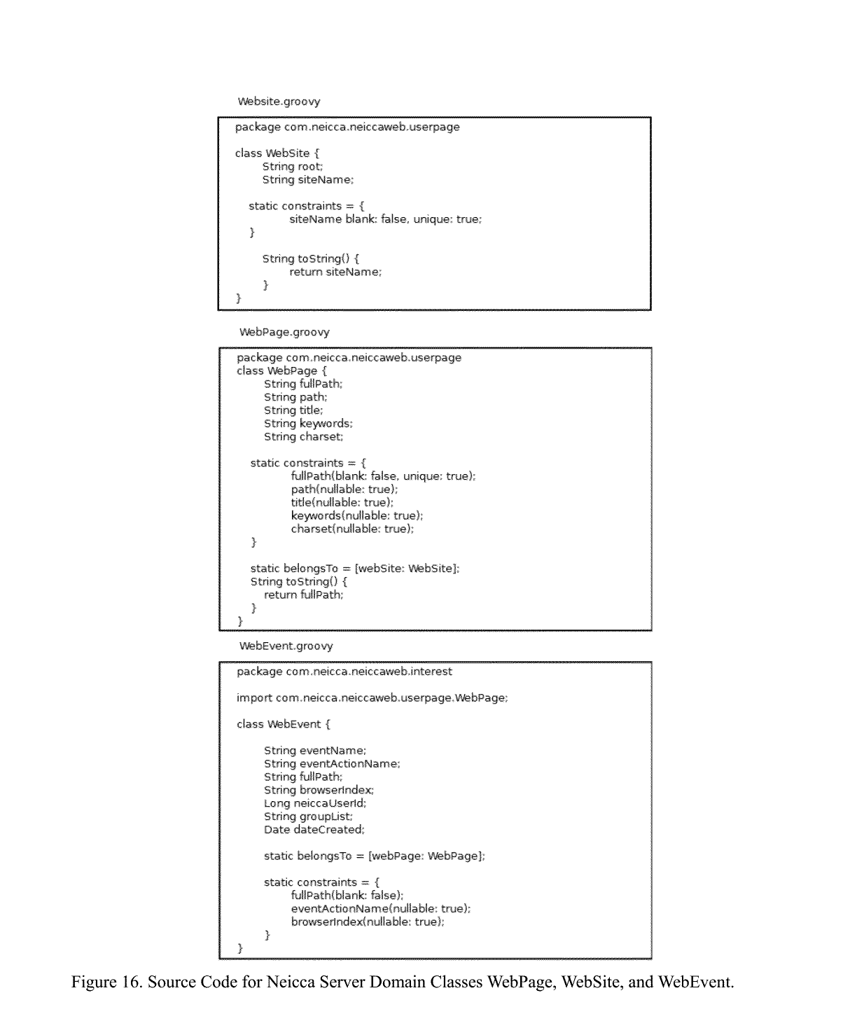

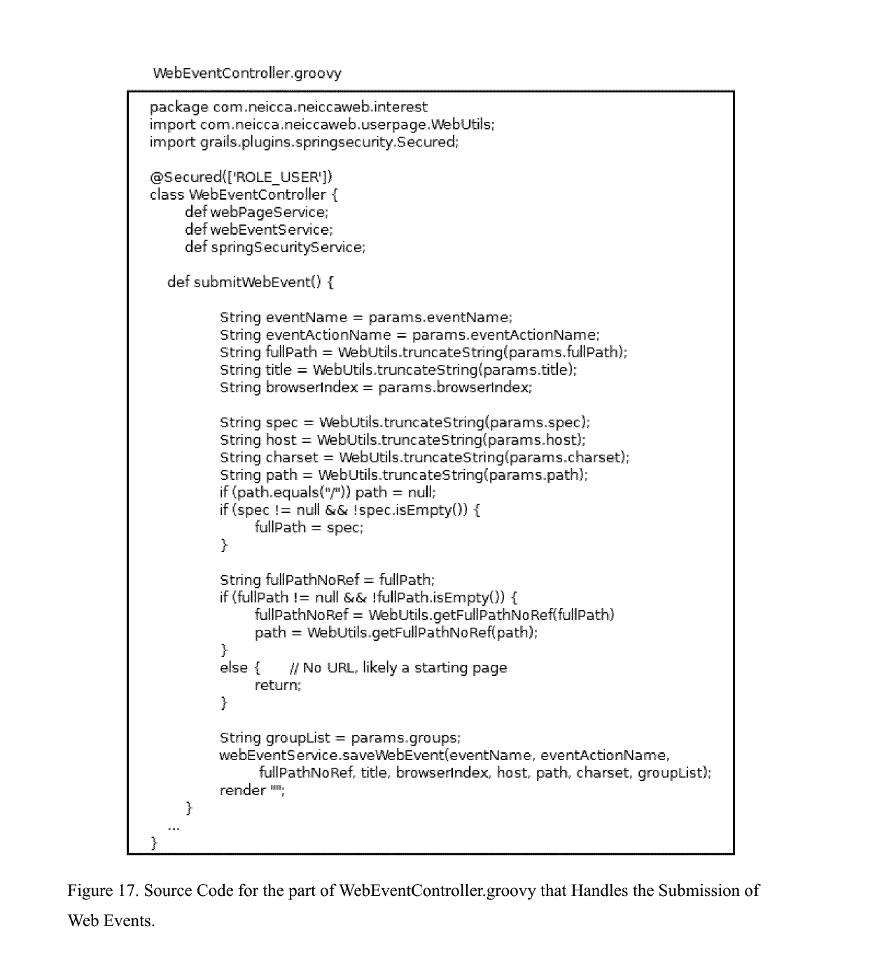

FIG. 14 shows the file structure of Neicca server project, emphasizing the classes that involve in the handling of user online activity data. FIG. 15 displays the diagram of Domain classes, Service classes, and Controller classes, as well as the information flow for accepting user activity data and storing these data in database. FIG. 16 shows the source code of domain classes WebPage.groovy, WebSite.groovy, and WebEvent.groovy. FIG. 17 shows the source code of a part of controller class WebEventController.groovy that handles the user online activity data submitted by Neicca extension.

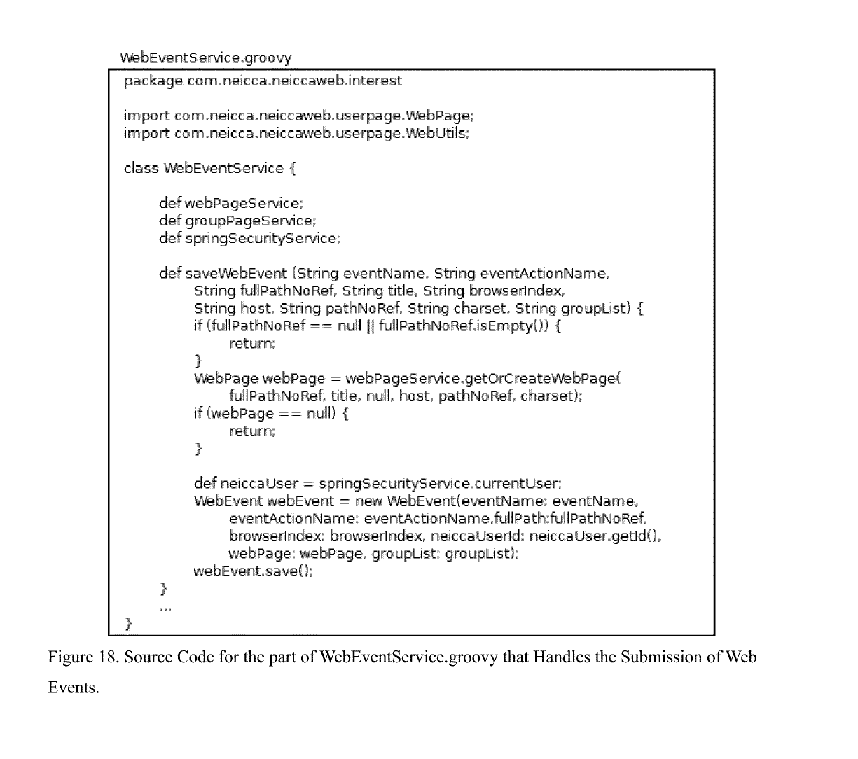

FIG. 18 shows the source code of a part of service class WebEventService.groovy that saves the user online activity data to Neicca database.

When Neicca extension detects a user's online activity, such as opening a web page, the code neiccaOverlay.js submitted the relevant data to an URL at Neicca server. The function “submitWebEvent” in the controller class WebEventController.groovy is called to handle this http call.

The function “submitWebEvent” parses the data and calls the function “saveWebEvent” in the service class WebEventService.groovy to save the data. The function “saveWebEvent” organizes the input data into domain objects, and then saves the data into the database.

### Mechanism of Submitting Online Activities to a Selected List of Groups

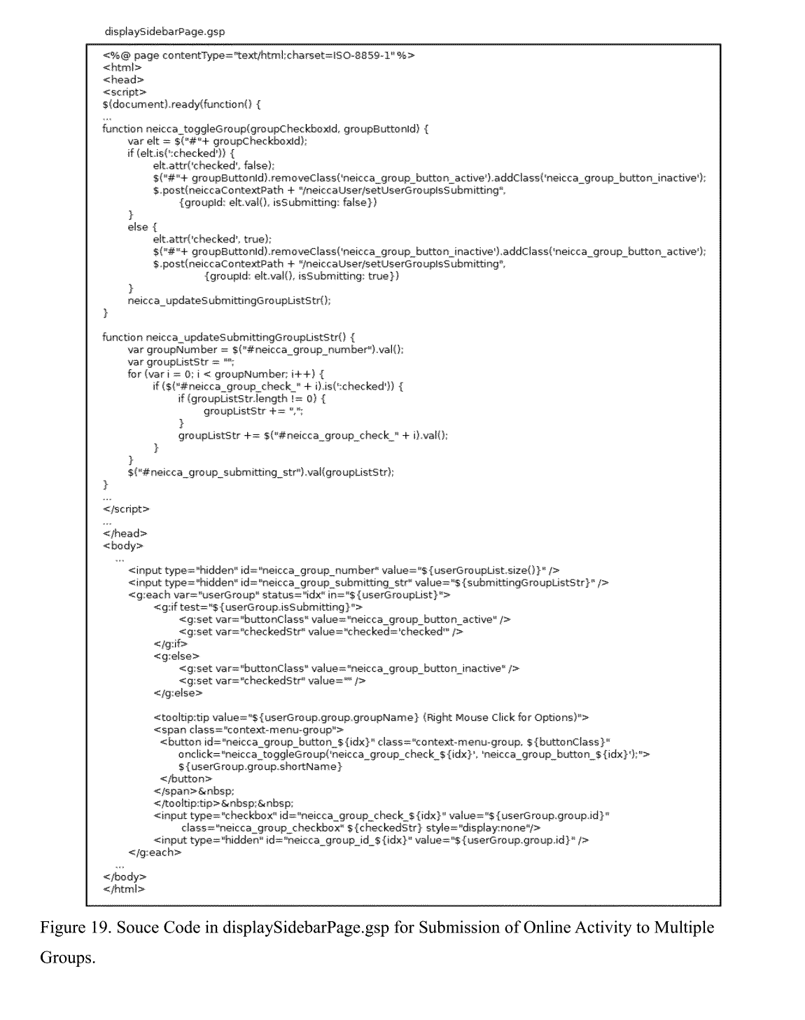

A user's online activities can be automatically submitted to selected groups and shared among members, when Neicca extension is activated. A user can also explicitly submit a URL to selected groups in the main page for Neicca community site. The implementation of this feature in Neicca extension and Neicca community main page uses the same code. Thus the mechanism for multiple groups submission is illustrated in FIG. 19, using the example of displaySidebarPage.gsp for Neicca extension.

When the user clicks on a group's icon, the event triggers the running of the Javascript function “neicca_toggleGroup.” This function issues an Asynchronous Javascript and XML (AJAX) call to Neicca server, and set the state of submitting to the clicked group to be the opposite of what was before. The color of the group icon is also changed to reflect the switching of its submission status.

Then the embedded “group string,” which is a concatenation of the IDs of the selected groups, is updated.

When Neicca extension or Neicca community main page submits the user online activities, the “group string” stored in the Javascript engine in the browser will be sent to Neicca server, along with the user activity data. After receiving these data, Neicca server stores the activity data into each group that is listed in the “group string.”

I claim:

1. A method of automatically sharing a plurality of a user's online activities, which includes but not limited to reading web pages, watching video, and listening to audio, among multiple groups, comprising:
a. detecting a computer user's online activities,
b. submitting the detected online activities from said user to a computer server automatically, without requiring said user to manually submit said online activities to said computer server,
c. sending the submitted online activities to all the members of the groups in with said user participated,
whereby said user can share online activities with the members of participating groups without the burden of manually submitting said activities, thus allowing said user to concentrate on the online activities themselves rather than being distracted by the sharing aspect.

2. The method of claim 1 wherein detecting a computer user's online activities is accomplished by software embedded in said computer user's internet browser that receives notifications of said user's online activity sent by the internet browser.

3. The method of claim 1 wherein detecting said user's online activities is accomplished by calculating the weighted sum of a plurality of parameters, including but not limited to, how long said user performs the activities, how many scroll actions said user performs, whether said user performs highlight action, and whether the user saves the URL of the web page as bookmark, etc.

4. The method of claim 1 wherein submitting the detected said user's online activities is accomplished by software embedded in said user's internet browser.

5. The method of claim 1 wherein sending the submitted online activities to all the members of the groups is accomplished by software running on a computer server and software embedded in the internet browser software used by the members of the groups.

6. A system of automatically sharing a plurality of a user's online activities among multiple groups, comprising:
a. software that detects a user's online activities,
b. software program that submits a computer user's online activities to a computer server automatically, without requiring the user to manually submit the online activities to the computer server, and
c. software program that provides a computer user a plurality of online activities that are submitted by the members of the groups that the user participated in,
whereby the user can share online activities with the members of participating groups without the burden of manually submitting these activities, thus allowing the user to concentrate on the online activities themselves rather than being distracted by the sharing aspect.

7. The system of claim 6 wherein the software that detects a user's online activities is a part of an extension of an internet browser, which receives notification from said internet browser about said user's online activities, including but not limited to, how long said user performs the activities, how many scroll actions said user performs, whether said user performs highlight action, and whether the user saves the URL of the web page as bookmark, etc.

8. The system of claim 6 wherein the software that submits a user's online activities is a part of an extension of an internet browser.

9. The system of claim 6 wherein the software that provides a computer user a plurality of online activities that are submitted by the members of the groups that the user participated in, is a part of an extension of an internet browser.

10. A method of automatically collecting a user's online activities, comprising:
a. detecting a computer user's online activities, including but not limited to the URL of the web page, how many pages the user reads into the web page, how long the user reads the web page, whether the user highlights any portion of the web page, and whether the user saves the URL of the web page, etc., and
b. submitting the detected online activities from said user to a computer server automatically, without requiring the user to manually submit the online activities to the computer server,
whereby the user can share online activities with the members of participating groups without the burden of manually submitting these activities, thus allowing the user to concentrate on the online activities themselves rather than being distracted by the sharing aspect.
